(19) United States
(12) Patent Application Publication
(10) Pub. No.: US 2012/0260272 A1
(43) Pub. Date: Oct. 11, 2012

(54) DISK DEVICE

(75) Inventors: Yuji SHIDA, Chiba (JP); Kenji KIUCHI, Kanagawa (JP)

(73) Assignee: Sony Corporation, Tokyo (JP)

(21) Appl. No.: 13/430,922

(22) Filed: Mar. 27, 2012

(30) Foreign Application Priority Data
Apr. 8, 2011 (JP) 2011-085993

(51) Int. Cl. G11B 33/14

(52) U.S. Cl. 720/650; G9B/33.049

(57) ABSTRACT

Provided is a disk device, including: a disk mounting portion; a pickup slider; a shaft configured to move the pickup slider; a conductive wire that contacts or is arranged in the vicinity of at least the shaft; and a ground component arranged such that the ground component contacts the conductive wire.

### BACKGROUND

The present disclosure relates to a disk device. More specifically, the present disclosure relates to an antistatic disk device.

FIG. 1 shows a disk device in related art. The disk device is mounted on, for example, a personal computer, a DVD player/recorder, a BD player/recorder, or the like.

FIG. 1 shows, as an example, a disk device 20 mounted on a PC 10.

The disk device 20 has, for example, the following structure. That is, the disk device 20 is slid out of the PC 10, and an optical disk such as, for example, a DVD or a BD may be placed in the disk device 20.

As shown in FIG. 1, the disk device 20 includes a disk placing area 21, a disk mounting portion 22, and a pickup 23. The disk placing area 21 is a circular area on which an optical disk such as a DVD or a BD is placed. The disk mounting portion 22 is provided at the center of the disk placing area 21, and is configured to drive/rotate the disk and fix the disk. The pickup 23 outputs laser beams for reading/writing data out of/in the disk.

Note that, for example, Japanese Patent Application Laid-open No. 2005-174532 (hereinafter, referred to as Patent Document 1) discloses such a disk device.

The disk mounting portion 22 and the pickup 23 are mounted on, for example, a component called traverse mechanism 30. The traverse mechanism 30 is structured as a component including electronic components for driving a disk and for reading/writing data out of/in the disk.

FIG. 2 shows an example of the structure of the common traverse mechanism 30 in related art.

The traverse mechanism 30 includes, in addition to the disk mounting portion 22 and the pickup 23, a pickup slider 41, a flexible substrate 42, shafts 43, a plurality of electronic components (connectors) 51, the sensor 52, and the like. The pickup slider 41 is configured to fix and slide the pickup. The flexible substrate 42 includes a signal input/output circuit with respect to the pickup, and includes other components. The shafts 43 are configured to slide the pickup slider 41. The plurality of electronic components (connectors) 51 has data processing and memory functions of the pickup and a disk drive.

Those respective structural components are fixed on a chassis 70 made of, for example, resin.

Further, a metal cover 71 configured to cover the entire chassis 70 is fixed by a plurality of fixing components (screws) 72. The metal cover 71 is provided to realize so-called electro-static discharge (ESD) for not accumulating static electricity in the respective components that structure the traverse mechanism 30.

Since the metal cover 71 is mounted, static electricity generated in the respective components in the traverse mechanism 30 is released to, for example, a housing of a main body of the PC or the like via the metal cover 71 and the fixing components (screws) 72.

Note that, in the traverse mechanism 30, a large amount of static electricity is generated in, for example, the electronic components 51 in which electric signals flow, the shafts 43 on which the pickup slider 41 slides, and the like.

Further, because, for example, a finger of a user bearing static electricity touches the traverse mechanism 30, static electricity may be accumulated in the traverse mechanism 30.

Static electricity generated in the components in the traverse mechanism 30 and static electricity generated when a user touches the traverse mechanism 30 are released to, for example, a housing of a main body of the PC or the like via the metal cover 71 and the fixing components (screws) 72.

As a result, the static electricity is not accumulated in the traverse mechanism 30, to thereby, for example, prevent malfunction of the electronic components 51, and the like.

However, it is necessary to, for example, manufacture a mold, perform sheet-metal processing by using the mold, and the like to manufacture the metal cover 71, which leads to a problem of increase in cost. Further, a problem of increase in weight of the entire device is also generated because a metal plate is used.

### SUMMARY

It is desirable to provide an antistatic disk device without a metal cover.

According to an aspect of the present disclosure, there is provided a disk device, including: a disk mounting portion; a pickup slider; a shaft configured to move the pickup slider; a conductive wire that contacts or is arranged in the vicinity of at least the shaft; and a ground component arranged such that the ground component contacts the conductive wire.

Further, according to an embodiment of the disk device, the disk device further includes an electronic component. The conductive wire contacts or is arranged in the vicinity of the electronic component.

Further, according to an embodiment of the disk device, the conductive wire contacts or is arranged to run in the vicinity of two shafts configured to move the pickup slider, and contacts or is arranged to run in the vicinity of at least one electronic component.

Further, according to an embodiment of the disk device, the disk device further includes a sensor. The conductive wire contacts or is arranged in the vicinity of the sensor.

Further, according to an embodiment of the disk device, the ground component is a screw component arranged such that the screw component contacts the conductive wire.

According to the structure of the embodiment of the present disclosure, an antistatic disk device without a metal cover is provided.

Specifically, for example, a conductive wire is arranged so as to contact components such as shafts for moving a pickup slider, electronic components such as connectors, and a sensor, or run in the vicinity thereof. Further, the conductive wire is structured so as to contact a component having a ground function such as, for example, a screw. According to this structure, static electricity generated in a disk device and static electricity that flows in the disk device because of contact by a user may be released via the conductive wire and the component having a ground function such as a screw. Further, it is possible to prevent malfunction of the electronic components because of static electricity, and the like.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram for describing a structural example of a general disk device;

FIG. 2 is a diagram for describing a structural example of a general traverse mechanism;

FIG. 3 is a diagram for describing a structural example of a disk device according to the present disclosure; and

FIG. 4 is a diagram for describing a structural example of a traverse mechanism according to the present disclosure.

### DETAILED DESCRIPTION OF EMBODIMENTS

Hereinafter, a disk device according to an embodiment of the present disclosure will be described in detail with reference to the drawings.

The description will be made according to the following items.

(1) Embodiment of disk device of present disclosure

(2) Conclusion of structure of present disclosure

### (1) Embodiment of Disk Device of Present Disclosure

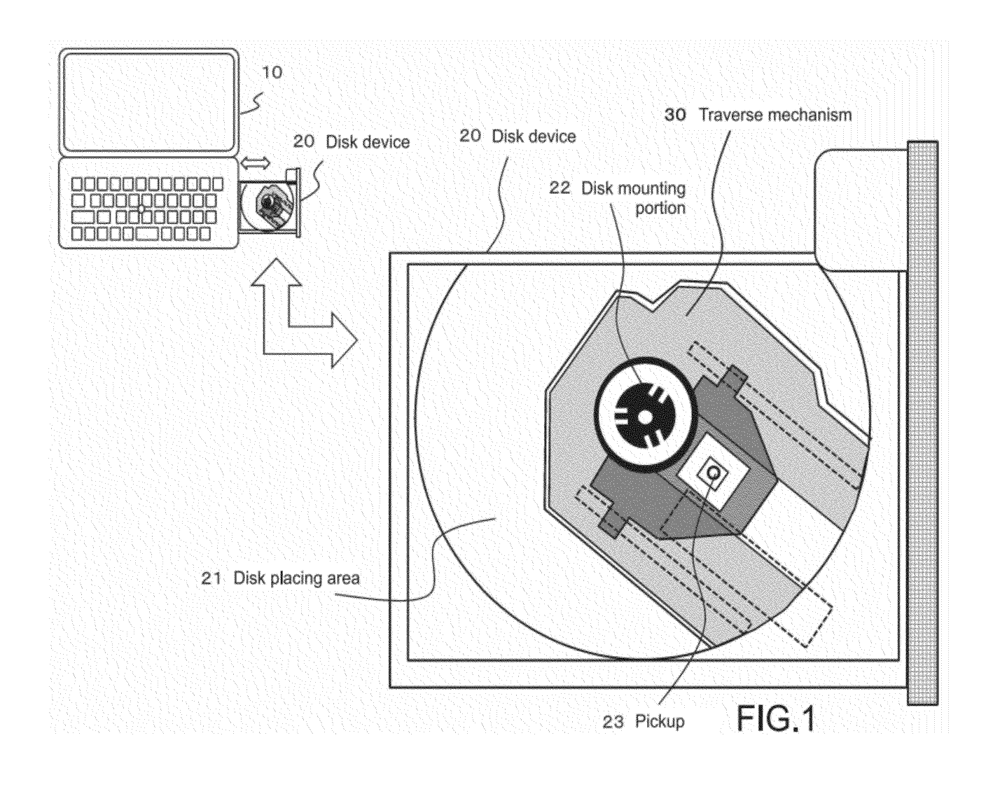

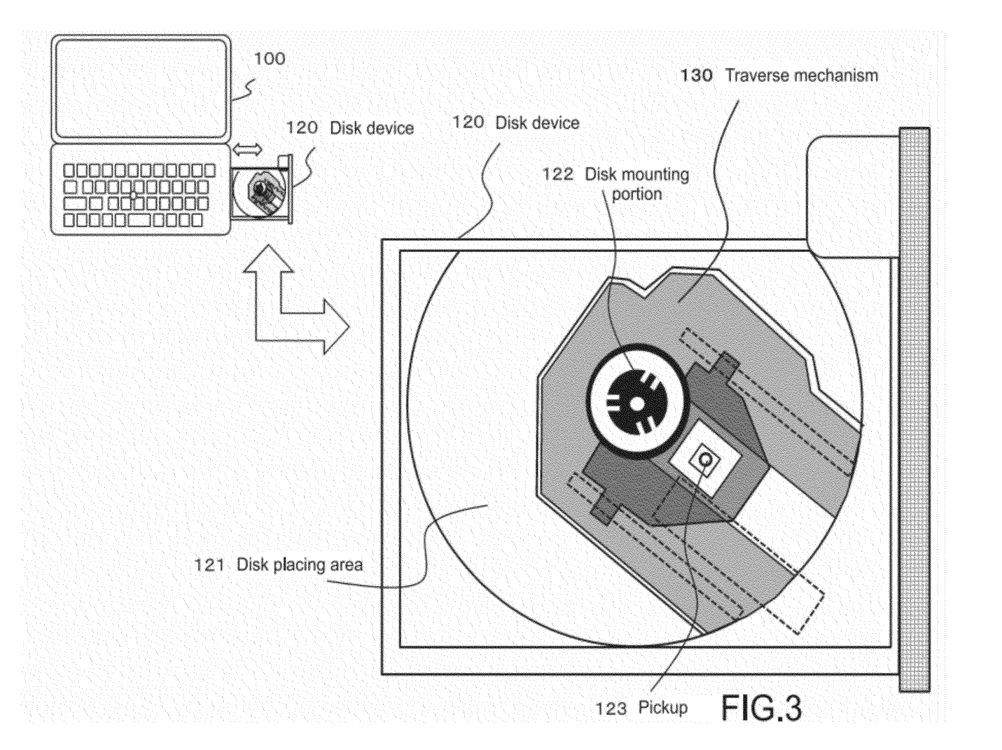

FIG. 3 shows a disk device 120 provided on the PC 100, as described with reference to FIG. 1 above.

Note that FIG. 3 shows the disk device 120 provided on the PC 100 as an example. Other than that, the disk device 120 may be mounted on various devices such as a DVD player/recorder and a BD player/recorder.

The disk device 120 has, for example, the following structure. That is, the disk device 120 is slid out of the PC 100, and an optical disk such as, for example, a DVD or a BD may be placed in the disk device 120.

As shown in FIG. 3, the disk device 120 includes a disk placing area 121, a disk mounting portion 122, and a pickup 123. The disk placing area 121 is a circular area on which an optical disk such as a DVD or a BD is placed. The disk mounting portion 122 is provided at the center of the disk placing area 121, and is configured to drive/rotate the disk and fix the disk. The pickup 123 outputs laser beams for reading/writing data out of/in the disk.

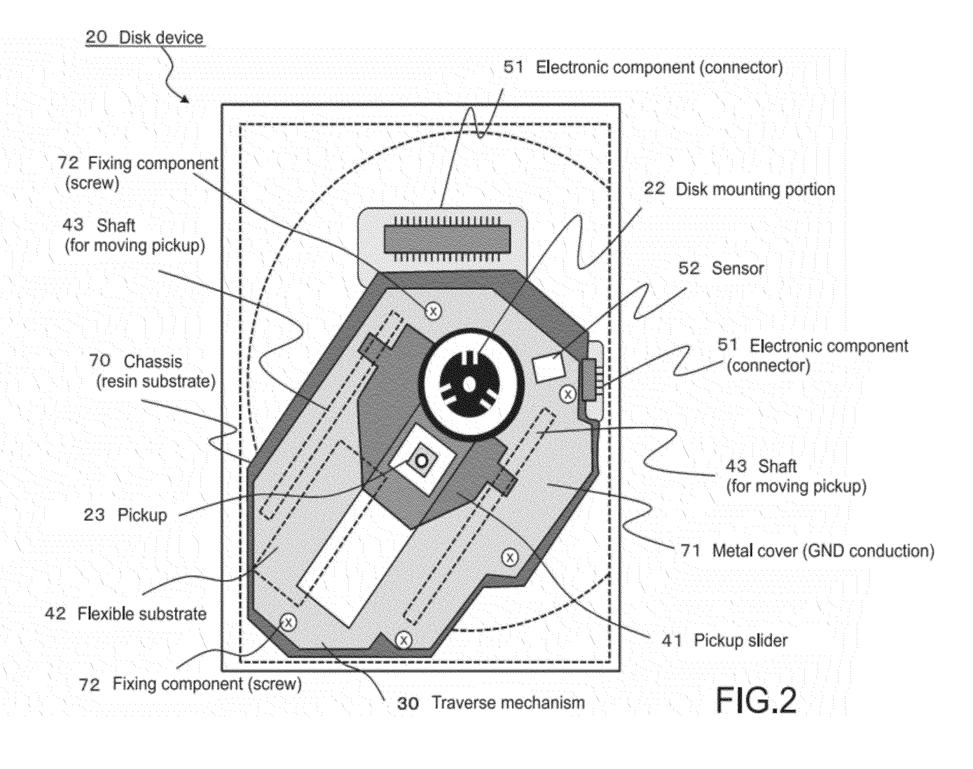

Similar to the above-mentioned structure in related art shown in FIGS. 1 and 2, the disk mounting portion 122 and the pickup 123 are mounted on a component called traverse mechanism 130. The traverse mechanism 130 is structured as a component including electronic components for driving a disk and for reading/writing data out of/in the disk.

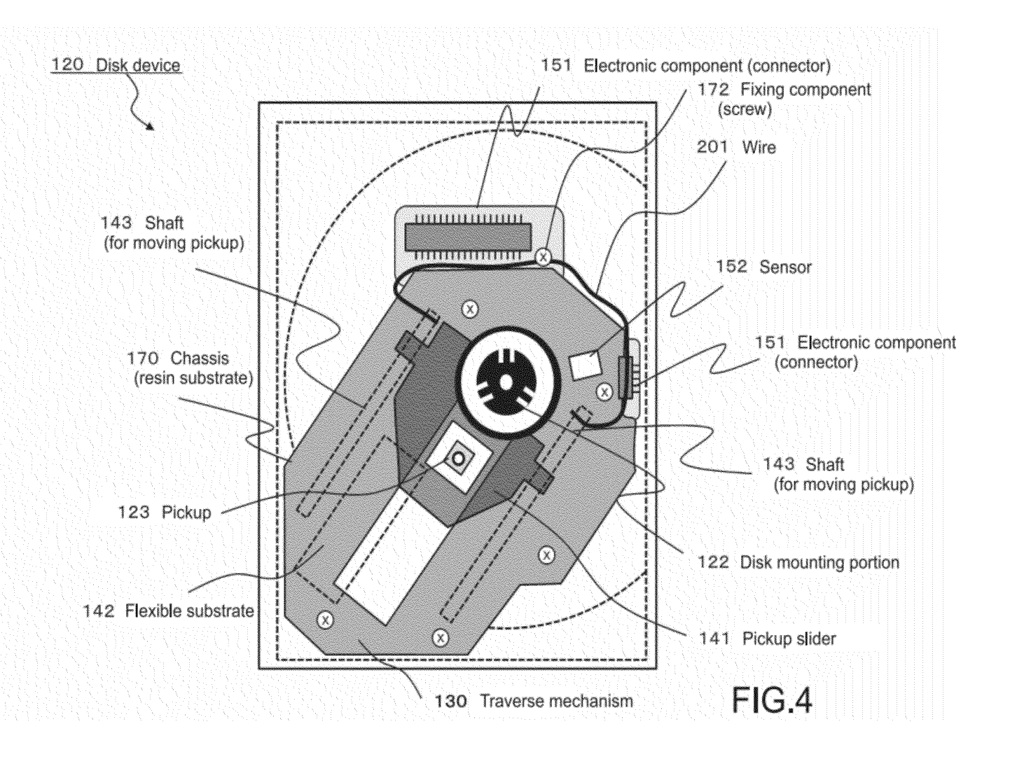

FIG. 4 shows an example of the structure of the traverse mechanism 130 according to the embodiment of the present disclosure.

The traverse mechanism 130 includes, in addition to the disk mounting portion 122 and the pickup 123, a pickup slider 141, a flexible substrate 142, shafts 143, a plurality of electronic components (connectors) 151, the sensor 152, and the like. The pickup slider 141 is configured to fix and slide the pickup. The flexible substrate 142 includes a signal input/output circuit with respect to the pickup, and includes other components. The shafts 143 are configured to slide the pickup slider 141. The plurality of electronic components (connectors) 151 has data processing and memory functions of the pickup and a disk drive.

Those respective structural components are fixed on a chassis 170 made of, for example, resin.

Those structures are similar to the structures described with reference to FIG. 2.

The difference between the structure of the common traverse mechanism in related art described with reference to FIG. 2 and the traverse mechanism 130 according to the embodiment of the present disclosure shown in FIG. 4 is as follows. That is, the metal cover 71 described with reference to FIG. 2 is not mounted on the traverse mechanism 130 according to the embodiment of the present disclosure shown in FIG. 4.

As described with reference to FIG. 2 above, the metal cover 71 is mounted to realize electro-static discharge (ESD) for releasing static electricity in the traverse mechanism to the outside.

However, the traverse mechanism 130 according to the embodiment of the present disclosure shown in FIG. 4 has a structure without a metal cover.

In place of a metal cover, a wire 201 made of a conductive element is mounted on the traverse mechanism 130 shown in FIG. 4.

The wire 201 is made of a conductive element such as, for example, a steel member.

The wire 201 is arranged so as to contact a plurality of components that are likely to generate static electricity, or to run in the vicinity thereof.

As described above, in the traverse mechanism 130, a large amount of static electricity is generated in, for example, the electronic components 151 in which electric signals flow, the shafts 143 on which the pickup slider 141 slides, and the like. Further, because, for example, a finger of a user bearing static electricity touches the traverse mechanism 130, static electricity may flow in the traverse mechanism 130.

As shown in FIG. 4, the wire 201 is arranged so as to contact the electronic components 151 in which electric signals flow, the sensor 152, and the shafts 143 on which the pickup slider 141 slides, or run in the vicinity thereof.

That is, the wire 201 is arranged so as to contact components that are likely to generate static electricity and components that are likely to malfunction because of static electricity, or run in the vicinity thereof.

Further, the wire 201 is set so as to contact a conductive fixing component (screw) 172. The conductive fixing component (screw) 172 is electrically connected to a housing of a main body device of a PC, for example. The wire 201 is capable of realizing electro-static discharge (ESD). That is, the fixing component (screw) 172 has a role of a ground component.

As described above, the wire 201 connected to a component having a ground function is mounted on the traverse mechanism 130. Therefore, static electricity generated in the respective components in the traverse mechanism 130 and static electricity that flows in the traverse mechanism 130 because of contact by a user and the like, for example, are released via the wire 201 and the fixing component (screw) 172. As a result, static electricity is not accumulated in the traverse mechanism 130, to thereby, for example, prevent malfunction of the electronic components 151, and the like.

Note that the arrangement of the wire 201 shown in FIG. 4 is an example. The arrangement of the wire 201 may be set variously according to the arrangement structure of the components on the traverse mechanism.

Note that there may be employed an arrangement structure in which the wire 201 contacts components that are likely to generate static electricity and components that are likely to malfunction because of static electricity, or runs in the vicinity thereof.

According to the structure of this embodiment of the present disclosure, without using a metal cover shown in FIG. 2, the structure only using the wire 201 shown in FIG. 4 realizes ESD. A wire requires no manufacturing process using a mold, which is different from a metal plate. Further, the manufacturing cost is reduced, and increase in weight because of mounting of a metal plate may be avoided. Such advantageous effects may be obtained.

### (2) Conclusion of Structure of Present Disclosure

Heretofore, an embodiment of the present disclosure has been described in detail with reference to a certain embodiment. However, it should be understood by those skilled in the art that various modifications, combinations, sub-combinations and alterations may occur depending on design requirements and other factors insofar as they are within the scope of the appended claims or the equivalents thereof.

Note that the technology disclosed in the specification may employ the following structures.

(1) A disk device, comprising:

a disk mounting portion;

a pickup slider;

a shaft configured to move the pickup slider;

a conductive wire that contacts or is arranged in the vicinity of at least the shaft; and

a ground component arranged such that the ground component contacts the conductive wire.

(2) The disk device according to (1), further comprising:

an electronic component, wherein

the conductive wire contacts or is arranged in the vicinity of the electronic component.

(3) The disk device according to (1) or (2), wherein

the conductive wire contacts or is arranged to run in the vicinity of two shafts configured to move the pickup slider, and contacts or is arranged to run in the vicinity of at least one electronic component.

(4) The disk device according to any one of (1) to (3), further comprising:

a sensor, wherein

the conductive wire contacts or is arranged in the vicinity of the sensor.

(5) The disk device according to any one of (1) to (4), wherein

the ground component is a screw component arranged such that the screw component contacts the conductive wire.

Heretofore, as described above, according to the structure of the embodiment of the present disclosure, an antistatic disk device without a metal cover is provided.

Specifically, for example, a conductive wire is arranged so as to contact components such as shafts for moving a pickup slider, electronic components such as connectors, and a sensor, or run in the vicinity thereof. Further, the conductive wire is structured so as to contact a component having a ground function such as, for example, a screw. According to this structure, static electricity generated in a disk device and static electricity that flows in the disk device because of contact by a user may be released via the conductive wire and the component having a ground function such as a screw. Further, it is possible to prevent malfunction of the electronic components because of static electricity, and the like.

The present disclosure contains subject matter related to that disclosed in Japanese Priority Patent Application JP 2011-085993 filed in the Japan Patent Office on Apr. 8, 2011, the entire content of which is hereby incorporated by reference.

What is claimed is:

1. A disk device, comprising:
a disk mounting portion;
a pickup slider;
a shaft configured to move the pickup slider;
a conductive wire that contacts or is arranged in the vicinity of at least the shaft; and
a ground component arranged such that the ground component contacts the conductive wire.

2. The disk device according to claim 1, further comprising:
an electronic component, wherein
the conductive wire contacts or is arranged in the vicinity of the electronic component.

3. The disk device according to claim 2, wherein
the conductive wire contacts or is arranged to run in the vicinity of two shafts configured to move the pickup slider, and contacts or is arranged to run in the vicinity of at least one electronic component.

4. The disk device according to claim 1, further comprising:
a sensor, wherein
the conductive wire contacts or is arranged in the vicinity of the sensor.

5. The disk device according to claim 1, wherein
the ground component is a screw component arranged such that the screw component contacts the conductive wire.
